(19) United States
(12) Patent Application Publication
(10) Pub. No.: US 2009/0062093 A1
(43) Pub. Date: Mar. 5, 2009

(54) Beanbag Yoga Block

(76) Inventor: Patrick Joseph Clark, Burnsville, NC (US)

Correspondence Address: Patrick Clark, 289 Twilight Way, Burnsville, NC, 28714, US

(21) Appl. No.: 11/849,282

(22) Filed: Sep. 1, 2007

(51) Int. Cl. A63B 26/00; B23P 11/00

(52) U.S. Cl. 482/148; 29/428

(57) ABSTRACT

A beanbag yoga block comprised of a sewn cover and firmly filled with loose flowing, pellet-like material. This new construction method provides the essential effects of a rigid block or brick, with the added benefits a soft yoga block provides. The dimensions of the invention do not vary widely from 4 inches (height) by 6 inches (width) by 9 inches (length), which are the predetermined dimensions of traditional (prior art) yoga blocks and which allow the full functioning of the beanbag yoga block for its intended purposes. The beanbag yoga block serves all the requirements of traditional yoga blocks, whereby adding the advantages: economical, environmentally-friendly, wider market appeal, versatility of use, versatility of design, ease and comfort of use, and domestically produced materials which generate more revenue for the economy.

### CROSS REFERENCE

None

### FEDERAL SPONSORED RESEARCH

None

### SEQUENCE LISTING

None

### BACKGROUND OF THE INVENTION

This invention relates to yoga blocks (a.k.a yoga bricks) used for assistance in yoga poses, specifically to an improved construction method for said device. The invention is a standard block shape, which is constructed using sewn fabric and stuffed with a loose flowing, pellet-like material.

The yoga block is an ancient prop, which has the predetermined dimensions of approximately 4″ (height) by 6″ (width) by 9″ (length). The yoga block is used by a yoga practitioner to assist in certain poses, positions, stretches or asanas, usually those that require reaching the hand or hands to the floor. When the yoga practitioner is not able to reach the floor, the yoga block provides an elevated surface that allows the practitioner to carry out the pose, position, stretch or asana without unnecessary strain and pain. This invention not only makes an improved yoga block, but also provides new and unexpected uses not provided by existing yoga blocks.

Yoga blocks have been in the public domain for perhaps centuries. They are traditionally made from rigid materials like wood, cork, or foam. They can either be hollow or solid inside. These traditional construction methods and materials produce a yoga block with the necessary requirements: 1) the yoga block must stand on end when unsupported, 2) the yoga block must be close to said dimensions for ease of gripping with one hand and proper use in specific yoga positions, 3) the yoga block must be firm and supportive, not mushy with too much give when pressure is applied by the yoga practitioner. However, there is a need for a yoga block that is made from more environmentally friendly materials, requires less technologically advanced processes to manufacture, and is thus less expensive to manufacture than the above said materials. Also, there is a need for a soft yoga block which is softer and feels nice to the touch, and that can be used for multiple purposes, such as seated meditation, which is often practiced as one part of the typical yoga routine.

### BACKGROUND OF THE INVENTION

### Discussion of Prior Art

| | | | |
|---|---|---|---|
| 6,141,807 | Adjustable height pillow . . . | November 2000 | Tapper |
| D273,028 | Stuffed Toy | February 1982 | Finney |
| 7,156,791 | Yoga Grip Block | January 2007 | Edwards |
| 6,234,577 | Chair | May 2000 | Ruppert |

### Wood

Trees, which provide lumber, take 20-30 years of growth to be ready for harvest. This uses up valuable land and usually creates erosion after harvest. There is a trend, especially in the yoga market, towards finding alternatives to trees for products such as paper and furniture. Any yoga product, which is made with a smaller environmental impact, is going to have a huge economic advantage from a marketing standpoint.

### Cork

Cork is lightweight. However, it is a wood product and also has the disadvantage of growing in tropical climates, needing to be imported to the United States where the primary yoga market is located. Fiberboard, which is comprised of wood scraps, is environmentally friendly, however the cost of such a yoga block would be more than the market can bear.

### Foam

Foam yoga blocks made from petroleum pollute the air, land, and water. Some new foam yoga blocks are now made with non-petroleum based materials. However, these still require a complex technological process for manufacturing, and thus are expensive to manufacture.

### Fibrous Stuffing Materials

Kapok fiber was tested and proven unsuccessful in meeting the said three requirements. Other materials with similar properties to kapok were ruled out: wool, cotton batting, fabric scraps, feathers, and polyfill. Any material, which is fibrous and not pellet-like, does not provide the firmness and support needed. Also, a fibrous stuffing material creates a yoga block which does not stand on its end well because the block has overly rounded sides. The overly rounded sides result from the attempt to pack more material into the pillowcase to provide enough firmness for its use. These materials do not make a firm, stiff and stable block that effectively withstands the pressure applied during the necessary yoga poses, and while at the same time stands on its end unsupported. In my attempts at finding an alternative material for a yoga block, I found that a yoga block stuffed with fibrous materials fell short of satisfactory

### Buckwheat Hulls

Buckwheat hulls are the chaff or husk that is a by-product of the groat that is used for food. Buckwheat hulls have been used for stuffing pillows for sleeping and sitting in Japan for centuries. These pillows and seats have become popular in America by people interested in healthy living, yoga, and environmentally friendly furniture. Buckwheat is one of the most comfortable and environmentally friendly pillow stuffing materials available. It grows on poor soils and actually enhances the soil's fertility, thus needing no chemical fertilizers. Buckwheat has no significant pests, thus needing no chemical insecticides. Because it grows quickly and is leafy, it needs no herbicides. Buckwheat is grown mostly in the Northern U.S. and Canada, so importing is not necessary.

### Construction Methods for Pellet-stuffed Cushions

There are two basic types of buckwheat construction methods: a loosely packed “bean bag” type construction, and a tightly packed method that takes on a rigid shape. When a buckwheat pillow or cushion is made by loosely packing the buckwheat hulls into the form or case, the result is a malleable object. In the method where the buckwheat hulls are stuffed firmly into a sewn case, the buckwheat hulls become rigid and take on the shape of the case. This results in a firm object. For this method, the hulls must be tightly packed into the case with very little room left.

It is this firm method of packing hulls into a case that creates an ideal yoga block. A yoga block, which is made from firmly stuffed buckwheat hulls, has the essential qualities of the wooden and the foam yoga blocks. It is not as rigid as the wooden or foam yoga blocks, but it is rigid enough. A buckwheat yoga block constructed in this manner can stand freely on its end while the yoga practitioner places her/his hand for support.

Many yoga practioners are now seeking environmentally friendly materials to compliment their practice. There is a growing concern over the global environmental crisis. Imported products are not only costing more and more for transport, but also weakening the U.S. economy by making us dependant on foreign countries for our energy and manufacturing needs. The buckwheat yoga block is one answer to finding a domestic source of materials for a common item. Since one of the main tenets of yoga practitioners is to create no harm, a more environmentally friendly yoga block would be a significant improvement.

Other stuffing materials will work as well as buckwheat hulls. Anything that is loose flowing and pellet-like, such as polystyrene pellets, beans, rice, millet hulls, or beads made from any hard material will work. Buckwheat hulls are the current embodiment of the invention, having environmental and esthetic advantages, but are no means the full scope of the invention.

The beanbag yoga block has some aesthetic and user-friendly advantages over wooden, cork and foam yoga blocks. The beanbag yoga block has a nicer feel and breathes better, which is a welcome quality especially since there can be a lot of sweating during yoga practice. The softness of the beanbag yoga block is more like a cushion than a hard object, which provides a more comfortable experience. It also has more versatility than a block made from rigid materials: such as use as a pillow or prop where padding is necessary. The beanbag yoga block can even be constructed in a way to resemble and serve as a stuffed animal, which would have wide appeal for children.

### New and Unexpected Result

Combining the properties of a rigid block with those of a soft cushion brings an unusual result. Yoga blocks are sometimes used to sit on for seated meditation. The yoga practitioner sits on the broad, flat surface. The yoga block is not specifically designed nor intended for this use, but since it's handy and it does work, it is often used. The beanbag yoga block works better for this use than the traditional rigid type of yoga block. The beanbag yoga block is soft, malleable, and widens to create a slightly larger seat that slopes downward, thus providing the needed tilt to the pelvis to allow proper posture. Sitting on a stiff, hard yoga blocks made from wood, foam, cork and similar materials will not come close to the comfort provided by a beanbag yoga block. In addition, two beanbag yoga blocks placed side-by-side create the effect of one longer cushion, which makes a lotus-seat or prop for autonomous (without back support) sitting in the cross-legged or lotus position. This combination of two beanbag yoga blocks placed side by side is a new and unexpected result, creating essentially an entirely new use for the invention.

### About the Dimensions

These said predetermined dimensions allow proper functioning of device, whereby the device functions in accord with its intended use and allows one to easily grasp the device with one hand to pick it up or move it. Said dimensions also provide the proper height for effectively elevating the surface of floor or ground, which is the expressed purpose of the beanbag yoga block and prior art.

A cushion or block that is much larger than this would be used for different purposes, such as a yoga bolster (which typically measures 20-27 inches long by 14 inches wide by 8 inches deep) used in a different set of poses, positions, stretches, and asanas, or a square meditation seat which measures roughly 12×14×10 which is used in certain seated meditation positions.

A yoga bolster is a stuffed cushion and is similar to a yoga block. However, the yoga bolster is used for completely different poses and the two cannot be substituted. The yoga bolster is primarily used in poses where the person's back is placed on it while the bolster lies flat on the floor. The yoga block (both prior art and the invention) is primarily used while a person is standing by placing her or his hand on the top surface. Since the dimensions and uses are distinctly different, the yoga bolster is obviously an entirely different object.

Bean Bag chairs have been in the public domain for several decades. The beanbag chair is constructed by loosely packing pellet-like material into a sewn cover, which is normally a rounded or oblong shape with a diameter of around 3 feet. Neither the construction nor use nor dimensions of the beanbag chair are the same as those of the invention, so the said chair is therefore obviously not the same as the beanbag yoga block.

U.S. Pat. No. 6,234,577 to Ruppert recites a chair, which is similar to the beanbag chairs, which were popular in the 1960's. This device is a rigid chair, which is stuffed with beanbag type material. It is constructed in a way that makes it rigid, so it does not become misshaped when sat on. The construction of this device is similar to that of the invention. However, the use and dimensions are in variance with the beanbag yoga block. The beanbag stuffed hassock has been in the public domain for at least a few decades. Said hassock is constructed in the shape of a cube roughly measuring 14″ by 14″ by 14″ minimally to 24″×24″×24″. It may be larger and smaller by a few inches, but is nowhere near the dimensions of the beanbag yoga block. Though the construction of this article is similar to the beanbag yoga block, the dimensions and use are obviously not the same as the beanbag yoga block.

The buckwheat hull pillow—which has been used for centuries in Asia—is constructed of similar materials and methods as the beanbag yoga block. However, the buckwheat pillow is typically the dimension of roughly 14″ by 16″ by 1-3″ thick. The hulls are loosely packed, which creates a beanbag type pillow. The buckwheat pillow is obviously a different shape, construction, and use than the beanbag yoga block.

U.S. Pat. No. 7,156,791 to Edwards is a Yoga Grip Block used in yoga positions. This device is used in some yoga poses, which are similar to that of standard yoga blocks, as well as the yoga poses, which the invention is used for. However, the primary purpose of the Yoga Grip Block is to provide support in poses other than that of a standard yoga block. The purpose of the Yoga Grip Block is to provide relief to the wrists during certain positions, which require the practitioner to place the hands on the floor, such as while doing a pushup. This is distinctly different than the purpose of a standard yoga block, which is to provide an elevated surface from the floor so the practitioner does not have to bend down completely during certain positions, to take some strain off the legs and back. Also, the shape, dimensions, construction method, materials and use of the Yoga Grip Block are in variance with the beanbag yoga block.

U.S. Pat. No. 6,141,807 to Tapper recites an invention called Adjustable Height Pillow and Related Furniture. This device is a cushion, which is stuffed with a loose flowing, pellet-like material in the shape of a round object or sphere, used for sitting. Although this is a stuffed object with some similar construction methods as the beanbag yoga block—its shape, dimensions, and use are in variance with the beanbag yoga block.

### SUMMARY

The invention, a beanbag yoga block, is constructed of sewn material and stuffed with lose flowing, pellet like material; not deviating far from the dimensions 4″ by 6″ by 9″. Accordingly, several objects and advantages of the invention are to provide an improved yoga block, to provide a more user-friendly yoga block which is more comfortable to use, to provide a less expensive yoga block, to provide a yoga block with more versatility and uses such as sitting, to provide a yoga block with more design appeal, and to provide a yoga block which is more environmentally-friendly than previous yoga blocks.

### DRAWINGS

2—Edge showing length
3—Edge showing width
4—Edge showing height
5—Zipper
6—Handle
7—Left side panel
8—Back side panel
9—Right side panel
10—Front side panel
11—Bottom side panel
12—Top side panel
13—Filling material

### DETAILED DESCRIPTION

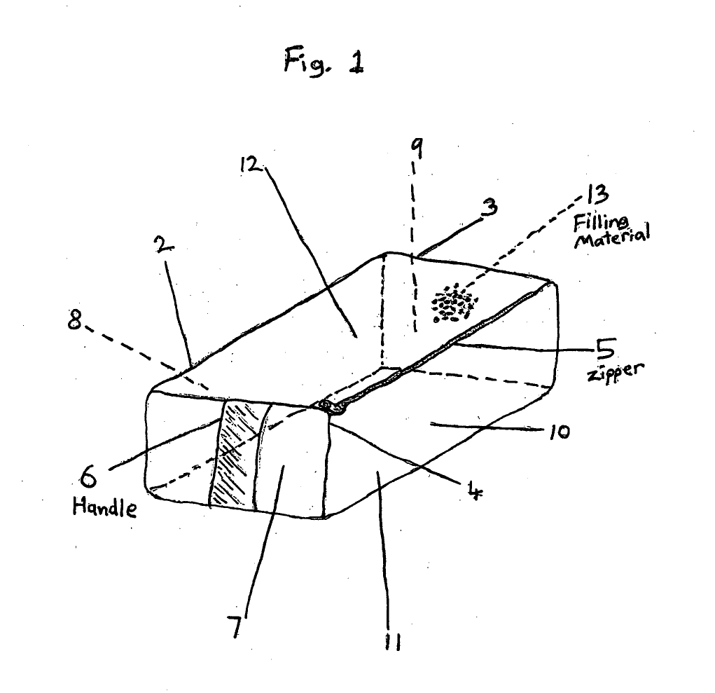

FIG. 1 is an assembled view constructed in accordance with the beanbag yoga block. The basic brick or block shape consists of six sides 7, 8, 9, 10, 11 and 12. Each of said sides is comprised of an individual rectangular-shaped cloth panel. All panels except 10 and 12 are connected by simple sewn seams. Panels 10 and 12 are connected by a zipper sewn into the seam. The zippered opening 5 allows a means to turn the cloth cover inside out once the sewing is complete. Said zipper opening 5 also provides a means of adding or removing stuffing material as needed. The handle 6 sewn onto side 7 ads an element of style and allows the user a means to easily pick up the beanbag yoga block with one or two fingers.

The dimensions of the final product are: length 2 (nine inches); width 3 (6 inches); and height 4 (four inches). Said length 2 will not vary broadly from 9 inches. Said width 3 will not vary broadly from 6 inches. Said height 4 will not vary broadly from 4 inches. The beanbag yoga block is filled firmly with a loose flowing, pellet-like material 13 by means of the zippered opening 5.

### Operation

The invention operates like any traditional yoga block constructed of rigid material. Although the invention is comprised of sewn fabric and stuffed with a pellet like material, the end result is a firm object suitable for the purposes it is intended. The invention is placed on the floor directly near or beneath the user. The block then serves as an elevated floor surface, which allows the user to effectively carry out the desired yoga positions and stretches without unnecessary stress on the joints and muscles involved.

The foregoing detailed description has been given for clearness of understanding only, and no unnecessary limitation should be understood therefrom. While the present invention has been described with reference to the preferred embodiment and several alternative embodiments, which embodiments have been set forth in considerable detail for the purposes of making a complete disclosure of the invention, such embodiments are merely exemplary and are not intended to be limiting or represent an exhaustive enumeration of all aspects of the invention. The scope of the invention, therefore, shall be defined solely by the following claims:

1) A new method of construction for an article or prop used for the purposes of exercise and assisted stretching, mostly in the practice of yoga and physical therapy, comprising:
a) A rectangular cushion made from six panels 7, 8, 9, 10, 11, and 12 of sewn cloth cover and tightly filled with pellet or bean-like material 13.
b) Dimensions of said cushion are predetermined and do not vary broadly from a 4 inch height by 6 inch width by 9 inch length. These said dimensions allow proper functioning of device. Said dimensions allow user to easily grasp the invention with one hand to pick it up or move it. Said dimensions also provide the proper height for effectively elevating the surface of floor or ground, which is the expressed purpose of the invention and prior art.
c) Stuffing material is any of a variety of loose flowing substances including but not limited to: millet hulls, wheat chaff, (or other grain husks), plastic pellets, sand, gravel, sawdust, or other materials such as metal, ceramic, glass, or wooden beads.
d) Current embodiment of filling material 13 is buckwheat hulls.
e) Current embodiment of material for sewn cover is lightweight canvas or cotton twill fabric.
f) Some features of current embodiment of sewn cover construction consists of a handle 6 on one end of the block and a zipper 5 along one of the long edges 2, from which stuffing material 13 is added or removed.

2) the beanbag yoga block is used primarily for established and known yoga positions. These positions are usually ones which require reaching to the floor from a standing position.

3) The beanbag yoga block can also be used for other purposes such as sitting meditation, or as a support pillow in massage, sleeping, physical therapy, or as a stuffed toy.
All of these claims combined create a synergistic effect, whereby; the beanbag yoga block solves several problems relating to traditional, rigid yoga blocks. These advantages would be obvious to anyone familiar in the art of yoga. These advantages include but are not limited to: cost of manufacturing, environmental impact, market appeal, design versatility, use versatility, and improved comfort.
